(19) United States
(12) Patent Application Publication
(10) Pub. No.: US 2009/0099887 A1
(43) Pub. Date: Apr. 16, 2009

(54) Method of undertaking and implementing a project using at least one concept, method or tool which integrates lean six sigma and sustainability concepts

(76) Inventors: Michael S. Sklar, Huntington Woods, MI (US); Jason A. Schulist, Canton, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/974,409

(22) Filed: Oct. 12, 2007

(51) Int. Cl. G06Q 10/00; G06F 19/00; G06F 17/40

(52) U.S. Cl. 705/7

(57) ABSTRACT

A method of undertaking and implementing a project using at least one concept, method or tool which integrates Lean Six Sigma and Sustainability Concepts is provided. The method includes the steps of: a) collecting data regarding a project to be undertaken; b) analyzing the collected data to identify a problem associated with the project; c) defining a desired solution to the problem; and d) creating a plan of action based on the desired solution. At least one of steps a) through d) is performed utilizing at least one concept, method or tool which integrates Lean Six Sigma and financial and social and/or environmental sustainability concepts. The method also includes implementing the plan of action to obtain financial and social and/or environmental benefits.

### BACKGROUND OF THE INVENTION

1. Field of the Invention

This invention relates to methods of undertaking and implementing projects using at least one concept, method or tool which integrates Lean Six Sigma and sustainability concepts.

2. Background Art

A. Business Operating Systems

A Business Operating System (“BOS”) describes how a business intends to turn its mission, vision, guiding principles, and business strategies into a day-to-day operating philosophy. In essence, a BOS describes “what we do around here, how we do it, and (sometimes) why we do it.” Every company has a BOS; fewer companies have attempted to write it down or codify it.

The most famous example of a BOS may be Toyota's Toyota Production System (http://en.wikipedia.org/wiki/Toyota Production System). Many of Toyota's competitors have developed their own business operating system (e.g., the Ford Production System, the GM Production System). A BOS describes how the various aspects of a company's functions should function and be improved over time to deliver business results. It links the various elements of a company's operational tactics and strategies together into a coherent, aligned, effective system.

B. Prior Art Operating System

One Prior Art Operating System framework provides a common, consistent, systematic way to organize work, think about the work, and raise operating performance to a new level.

The Prior Art Operating System incorporate a number of performance improvement tools. The primary tool sets are Lean and Six Sigma. The Lean tools include the classic just-in-time manufacturing, inventory management, and continuous improvement tools aimed at eliminating the seven classic wastes (transportation, inventory, motion, walking, overproduction, overprocessing, and defects). The Lean approach emphasizes direct involvement of affect personnel, an iterative approach to eliminating waste (often called Plan-Do-Check-Act or the PDCA cycle), and process simplification.

The Six Sigma tools include the process control and statistical analysis tools aimed at reducing process and product variation. The Six Sigma approach emphasizes rigorous data analysis and projects structured using the Define-Measure-Analyze-Improve-Control or DMAIC framework. U.S. Pat. No. 7,181,353 discloses the integration of Six Sigma methodology into an inspection receiving process.

C. Lean Six Sigma

Lean and Six Sigma have substantially different approaches to operational improvement. Some tools are common to both methodologies, and each methodology claims the other is a subset of its more comprehensive approach. A number of organizations, including the Assignee of the present application, have chosen to adopt both methodologies and integrate them into a single continuous improvement methodology. The most commonly used term for such an integrated approach is “Lean Six Sigma” (i.e., LSS). The following U.S. patents describe the “Lean Six Sigma” approach: U.S. Pat. Nos. 7,006,878; 6,816,747; and 6,631,305. The leftmost portion of the Venn diagram in FIG. 2 lists a number of LSS tools.

D. Triple Bottom Line

From Wikipedia (http://en.wikipedia.org/wiki/Triple_bottom_line).

The Triple Bottom Line, a.k.a. “TBL,” “3BL” or “People, Planet, Profit,” captures an expanded spectrum of values and criteria for measuring organizational (and societal) success; economic, environmental and social. With the ratification of the UN ICLEI TBL standard for urban and community accounting in early 2007, this became the dominant approach to public sector full cost accounting. Similar UN standards apply to natural capital and human capital measurement to assist in measurements required by TBL, e.g., the ecoBudget standard for reporting ecological footprint.

In the private sector, a commitment to corporate social responsibility implies a commitment to some from of TBL reporting. This is distinct from the more limited changes required to deal only with ecological issues.

In practical terms, Triple Bottom Line accounting means expanding the traditional reporting framework to take into account environmental and social performance in addition to financial performance.

The phrase was coined by John Elkington in 1994. It was later expanded and articulated in his 1998 book Cannibals with Forks: the Triple Bottom Line of 21^{st} Century Business. Sustainability, itself, was first defined by the Brundtland Commission of the United Nationals in 1987.

The rightmost portion of the Venn diagram in FIG. 2 lists a number of 3BL tools.

The following U.S. patent publications are related to the present invention: 2006/0248002; 2006/0224441; 2005/0015287; 2005/0209905; and 2003/0110065.

### SUMMARY OF THE INVENTION

An object of the present invention is to provide a method of undertaking and implementing a project using at least one concept, method or tool which integrates Lean Six Sigma and sustainability concepts.

In carrying out the above object and other objects of the present invention, a method of undertaking and implementing a project using at least one concept, method or tool which integrates Lean Six Sigma and sustainability concepts is provided. The method includes:

a) collecting data regarding a project to be undertaken;

b) analyzing the collected data to identify a problem associated with the project;

c) defining a desired solution to the problem;

d) creating a plan of action based on the desired solution wherein at least one of steps a) through d) is performed utilizing at least one concept, method or tool which integrates Lean Six Sigma and financial and environmental sustainability concepts; and

implementing the plan of action to obtain financial and environmental benefits.

The method may further include the steps of identifying a team to solve the problem and refining scope of the project. The steps of identifying and refining may be performed utilizing at least one concept, method or tool which integrates Lean Six Sigma and sustainability concepts.

The at least one concept, method or tool may include at least a portion of a critical-to-sustainability tree.

The desired solution may be based on requirements of customers including environment.

The method may further include measuring the financial and environmental benefits. The step of measuring may be performed utilizing at least one concept, method or tool which integrates Lean Six Sigma and sustainability concepts.

The method may further include sustaining the measured benefits to obtain sustained benefits. The step of sustaining may be performed utilizing at least one concept, method or tool which integrates Lean Six Sigma and sustainability concepts.

The method may further include communicating the sustained benefits. The step of communicating may be performed utilizing at least one concept, method or tool which integrates Lean Six Sigma and sustainability concepts.

Further in carrying out the above object and other objects of the present invention, a method of undertaking and implementing a project using at least one concept, method or tool which integrates Lean Six Sigma and sustainability concepts is provided. The method includes:

a) collecting data regarding a project to be undertaken;

b) analyzing the collected data to identify a problem associated with the project;

c) defining a desired solution to the problem;

d) creating a plan of action based on the desired solution wherein at least one of steps a) through d) is performed utilizing at least one concept, method or tool which integrates Lean Six Sigma and financial and social concepts; and

implementing the plan of action to obtain financial and social benefits.

The method may further include identifying a team to solve the problem and refining scope of the project. The steps of identifying and refining may be performed utilizing at least one concept, method or tool which integrates Lean Six Sigma and sustainability concepts.

The at least one concept, method or tool may include at least a portion of a critical-to-sustainability tree.

The desired solution may be based on requirements of customers including community.

The method may further include measuring the financial and social benefits. The step of measuring may be performed utilizing at least one concept, method or tool which integrates Lean Six Sigma and sustainability concepts.

The method may further include sustaining the measured benefits to obtain sustained benefits. The step of sustaining may be performed utilizing at least one concept, method or tool which integrates Lean Six Sigma and sustainability concepts.

The method may further include communicating the sustained benefits. The step of communicating may be performed utilizing at least one concept, method or tool which integrates Lean Six Sigma and sustainability concepts.

Still further in carrying out the above object and other objects of the present invention, a method of undertaking and implementing a project using at least one concept, method or tool which integrates Lean Six Sigma and sustainability concepts is provided. The method includes:

a) collecting data regarding a project to be undertaken;

b) analyzing the collected data to identify a problem associated with the project;

c) defining a desired solution to the problem;

d) creating a plan of action based on the desired solution wherein at least one of steps a) through d) is performed utilizing at least one concept, method or tool which integrates Lean Six Sigma and financial, environmental and social concepts; and

implementing the plan of action to obtain financial, environmental and social benefits.

The method may further include identifying a team to solve the problem and refining scope of the project. The steps of identifying and refining may be performed utilizing at least one concept, method or tool which integrates Lean Six Sigma and sustainability concepts.

The at least one concept, method or tool may include a critical-to-sustainability tree.

The desired solution may be based on requirements of customers including community and environment.

The method may further include measuring the financial, environmental and social benefits. The step of measuring may be performed utilizing at least one concept, method or tool which integrates Lean Six Sigma and sustainability concepts.

The method may further include sustaining the measured benefits to obtain sustained benefits. The step of sustaining may be performed utilizing at least one concept, method or tool which integrates Lean Six Sigma and sustainability concepts.

The method may further include communicating the sustained benefits. The step of communicating may be performed utilizing at least one concept, method or tool which integrates Lean Six Sigma and sustainability concepts.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic diagram illustrating a distributed computer network which, when properly programmed, is capable of performing one or more steps of a method of at least one embodiment of the present invention;

FIG. 2 is a Venn diagram illustrating some Lean Six Sigma (LSS) tools, some Triple Bottom Line (3BL) tools and some Sustainable Lean Sigma (SLS) tools of at least one embodiment of the present invention;

FIG. 3 is a block diagram flow chart illustrating the steps of at least one embodiment of a method of the present invention;

FIG. 4 is a Pareto chart which is used, inter alia, to refine project scope, and in one embodiment illustrates substation water use;

FIG. 5 is a Fishbone diagram which is used to analyze current reality in the one embodiment;

FIG. 6 is a portion of a Critical-to-Sustainability tree which is a Sustainable Lean Sigma (SLS) tool used to define ideal state in the one embodiment;

FIGS. 7-13 are control charts which are classic statistical process control tools (i.e., LSS tools) used to measure progress/sustain goals in the one embodiment; and

FIGS. 14-16 are schematic block diagrams which provide an example of a complete Critical-to-Sustainability (CTS) tree for use in a line clearance project; FIG. 14 identifies specific economic sustainability issues; FIG. 15 identifies specific social sustainability issues; and FIG. 16 identifies specific economic sustainability issues.

### DETAILED DESCRIPTION OF THE PREFERRED EMBODIMENT(S)

In general, the present invention provides a method of undertaking and implementing a project using at least one concept, method, or tool which integrates Lean Six Sigma (LSS) and Triple Bottom Line (TBL) concepts. The tools are termed Sustainable Lean Sigma (i.e., SLS) tools or methods.

Sustainable Lean Sigma is a term of art of the Assignee of the present application to describe:

1) The application of Lean Six Sigma to environmental and social sustainability challenges.

2) The application of social and environmental sustainability practices to traditional business concerns.

3) The extension and enhancement of Lean Six Sigma with mental models, tools, and analysis frameworks from social and environmental sustainability practices.

4) The extension and enhancement of social and environmental sustainability practices with Lean Six Sigma mental models, tools, and analysis frameworks.

5) The development and application of mental models, concepts, analysis frameworks, and improvement tools that integrate Lean Six Sigma, social sustainability, and environmental sustainability practices.

6) The development of new mental models, continuous improvement approaches and tools, and analysis frameworks to address Triple Bottom Line (3BL) results in an integrated manner.

In essence, Sustainable Lean Sigma is the result of cross-pollinating and cross-applying Lean Six Sigma, social sustainability, and environmental sustainability practices. It extends the application of Lean Six Sigma from its traditional focus on economic issues to drive social and environmental bottom line results; extends the application of social and environmental sustainability methods to improve economic bottom line results; integrates Lean Six Sigma and environmental/social sustainability methods to synthesize new operational improvement tools, mental models, and analysis frameworks; and includes new tools inspired by and directed towards the challenge of satisfying all three bottom lines simultaneously.

As previously mentioned, 3BL includes three elements: environmental, social, and economic sustainability.

The 3BL paradigm aligns with employee values (80% of Americans consider themselves pro-environment, higher percentages claim a concern for their communities). Employees are more engaged and motivated if they view their organization's work to be important and consonant with their own personal values. More engaged employees lead to better business results (see The Gallup Organization's book, First Break All the Rules). The environmental crisis in its various dimensions (limited fresh water in some areas, climate change, soil degradation, etc.) tends to elevate the importance of environmental bottom line concerns in organizations' planning and priority-setting processes.

The pressure of ever more intense and global competition makes it hard for companies to invest in social/environmental projects unless they directly benefit competitiveness with high rates of return. Increased competition also makes it harder for any one organization to capture the benefits of addressing larger-scale issues, thereby exacerbating the collective action dilemma at the root of underinvestment in (and overconsumption of) public goods. Financial concerns and pressures tend to be more urgent (operating on weekly, quarterly, and annual cycles rather than the multi-year cycles typical of environmental and social systems), and the urgent tends to crowd out the important. Social and environmental concerns are not viewed as core to the mission of many organizations and most corporations; they are viewed as luxuries, while competitive and financial issues are seen as necessities. Finally, the set of techniques that can be used to “operationalize” economic concerns—to translate goals into actionable plans, projects, and activities that lead to desired outcomes with reasonable probabilities of success—is extensive, while the set of operational techniques to address social and environmental concerns in ways that benefit the acting organization is much less extensive, less repeatable, and less predictable.

Lean Six Sigma is one of the more successful operational techniques to achieve business (economic) results. The method of at least one embodiment of the present invention is based on the following:

1) Applying this discipline to the Triple Bottom Line can provide a proven methodology and tools to drive 3BL results.

2) Practices, tools, and mental models from the other 2 bottom lines can enrich the LSS discipline.

3) Practices, tools, and mental models from LSS can enrich the social and environmental sustainability disciplines.

4) 3BL can add meaning to LSS's drive for efficiency. For many, reducing cost and increasing profit is not a sufficient motivator to sustain their focus on continuous improvement, particularly when economic survival is not at stake. Adding social and environmental concerns can provide that missing meaning, which in turn can drive greater engagement.

5) Viewing the business or organization or customer through the 3BL lens can reveal multiple-value opportunities that otherwise would be hidden or insufficiently appreciated and hence undervalued.

As a result, the method of at least one embodiment of the present invention provides a robust operational methodology and tool set, strengths engagement, and makes environmental/social concerns a source of opportunity rather than a feel-good “fluff” activity.

The method of at least one embodiment of the present invention further leverages greater employee engagement into real results; and drives greater awareness of the environmental crisis as more members of the organization: work on 3BL projects; learn about environmental issues; and are prepared to capitalize on the gathering environmental crisis over time. 3BL-based strategies provide competitive advantages and make people and planet more central.

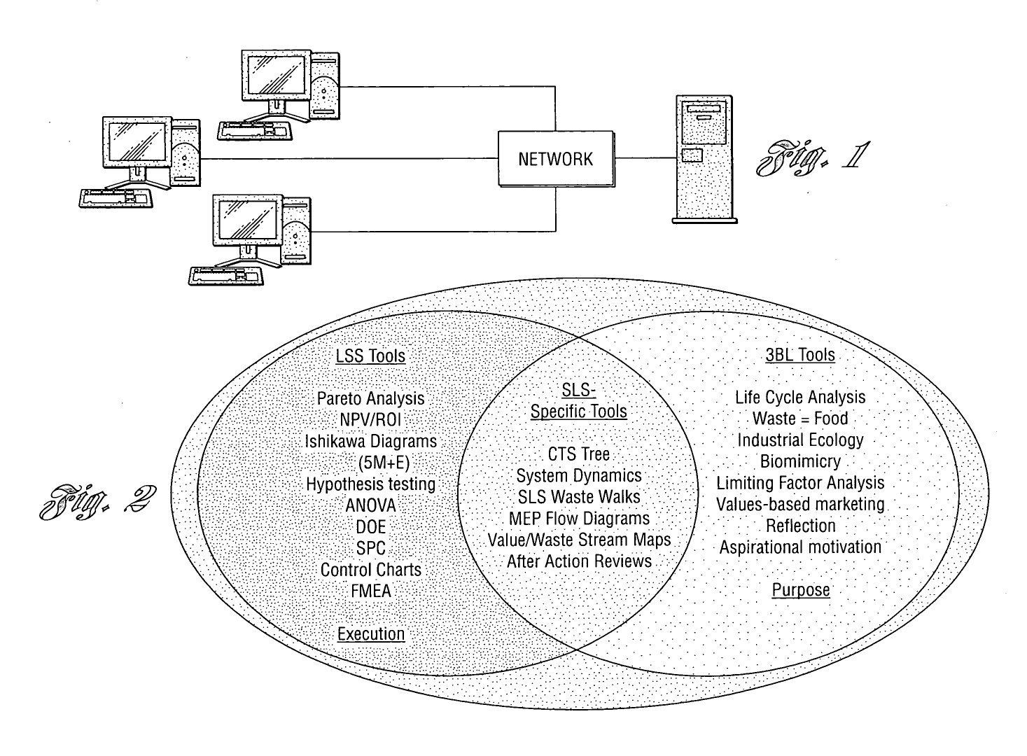

Referring to FIG. 1, there is illustrated a distributed computer network (i.e., a LAN/WAN) which, when properly programmed, can perform one or more steps of at least one embodiment of the present invention. The network is important to the following: communication; data storage, collection, and reporting; data analysis; graphical representation development; problem solving, and project management.

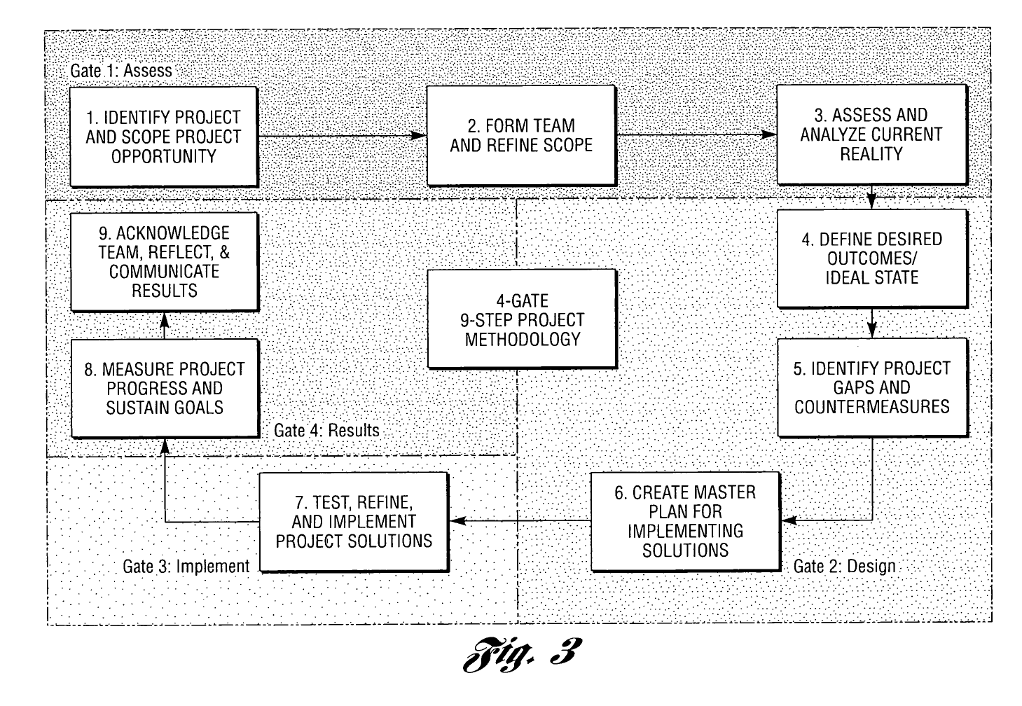

FIG. 2 is a Venn diagram showing some of the Lean Six Sigma tools and concepts, some of the tools and concepts developed by environmental/social sustainability practitioners, and some of the synthetic tools created for or based on an integrated perspective.

The integration of Lean Six Sigma and sustainability concepts enhances the value of both disciplines, and assists in embedding sustainability concepts, goals, and tools in an organization's business operating system. A sustainability perspective expands the focus of conventional Lean Six Sigma efforts, yielding additional opportunities to eliminate waste and identify additional sources of economic value. Lean Six Sigma helps drive sustainability thinking to a higher level of rigor and translate sustainability concepts into tangible, sustainable operational changes. Sustainable Lean Sigma can be readily adopted and implemented by an organization's Lean, Six Sigma, or Lean Six Sigma continuous improvement practitioners, who are already trained to think in terms of resource efficiency, continual improvement, and system dynamics and hence can quickly become effective sustainability change agents.

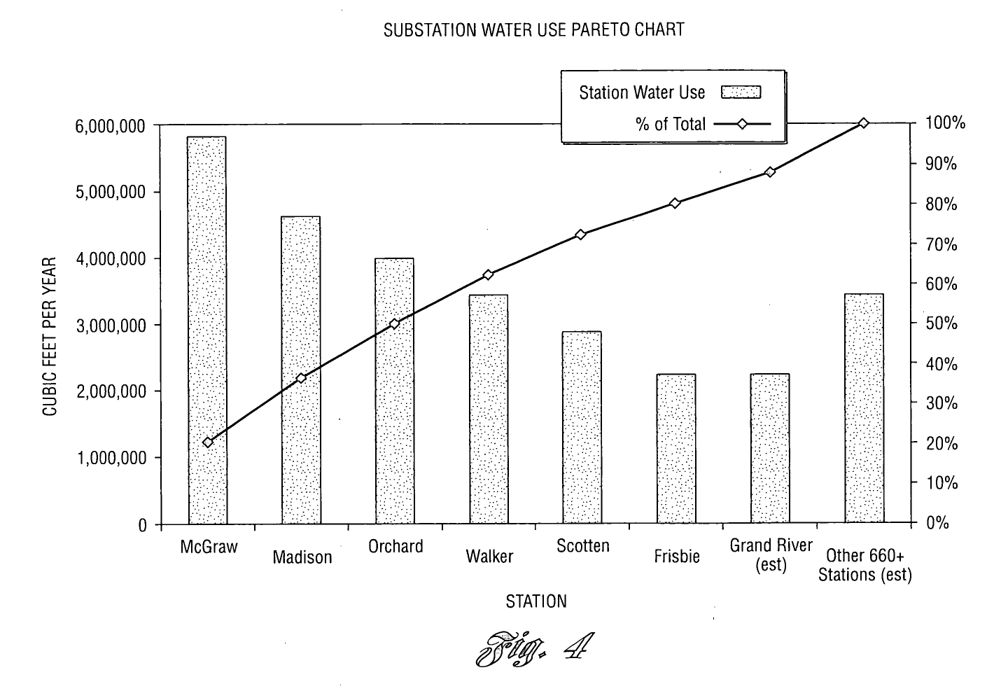

Referring now to FIG. 3, there is illustrated in block diagram flow chart form a methodology or steps applied to projects. Starting at the upper lefthand corner of FIG. 3, gate 1 includes steps 1, 2 and 3. In step 1 of gate 1 the project and scope project opportunity are identified to identify a problem. The following LSS concepts, methods, and tools may be utilized:
Voice of the Customer
SWOT analysis
Lean Waste Walks (7 Lean wastes)
4-Blocks
Environmental Scan (business/regulatory environment)
Benchmarking
Project Selection Criteria:
Results or Business Benefits
Feasibility
Organizational Impact.

The following SLS concepts, methods, and tools may be utilized in step 1:
Voice of the Environment
Voice of the Community
Ecological/Societal Scan
Aspirations Exercise (Dream Garden)
Natural Resource Walks
Community Capability Walks
Working In Context
SLS Waste Walks (12 SLS wastes)
Mass-Energy-Process Flow Diagrams
Community Advisory Board
Environmental Advisory Board
Ecological Footprint Analysis
Sustainability Indicators
Scenario Planning
3BL Kano Model
Aspirational Motivation
Cradle to Cradle
Extended Project Selection Matrix
Reflection
SIPOC³ Model
Sustainability
Sustainable Lean Sigma
Triple Bottom Line
Project Selection Criteria:
Environmental/social impacts
Environmental/social inputs
Environmental/social constraints.

In step 2 of FIG. 3, a team is formed. The team may include a core team, an external team and contractors. Some characteristics of the team may be:
Cross functional
Cross organizational
Cross-company
Multi-Level.

The following are LSS concepts, methods, and tools which may be used in step 2:
Project Charter
Critical-to-Quality Tree
SIPOC Model
Pareto Analysis.

The following are SLS concepts, methods, and tools which may be used in step 2:
Critical-to-Sustainability Tree
SIPOC³ (i.e., Supplier-Input-Process-Output-Customer to the third power) Model (a SIPOC model for the business customer(s) and the environmental customer(s))
Community Liaison
Community Advisory Board
Environmental Advisory Board
Sustainability
Sustainable Lean Sigma
Triple Bottom Line.

In step 3 of gate 1, current reality is analyzed.

The following LSS concepts, methods, and tools may be utilized in step 3:
SIPOC Model
Value Stream Map
Process Mapping
Pareto Analysis
Statistical tools (run charts, check sheets, histograms, hypothesis testing, regression analysis, reliability analysis, process capability/variation analysis, ANOVA, Design of Experiments, etc.)
Rolled Throughput Yield
Value-Added Activity Analysis
Root Cause Analysis/Cause and Effect (5M+E Fishbone)
Diagrams
Productivity/Uptime Analyses
Lean Waste Walks (7 Lean wastes).

The following SLS concepts, methods, and tools may be utilized in step 3:
SIPOC³ Model
Transformation Map
Mass-Energy-Process Flow Diagrams (MEP Flow Diagrams)
Limiting Factor Analysis
Life Cycle Analysis
Business-Environment-Community Interactional Dynamics Map (BEC Map)
5M+E³ Fishbone Diagram (where E³ represents Environment-Energy-Ecology)
Sustainability Indicators
Product:Service Flow Conversion Map
SLS Waste Walk (12 SLS wastes)
End-To-End (E2E) Conversion Efficiency
Cap-4 Analysis
Ecological Footprint Analysis
Community Current Account and Balance of Trade Analysis
Communities Connection Analysis
3BL Kano Model
Cradle to Cradle
Sustainability
Sustainable Lean Sigma
Triple Bottom Line.

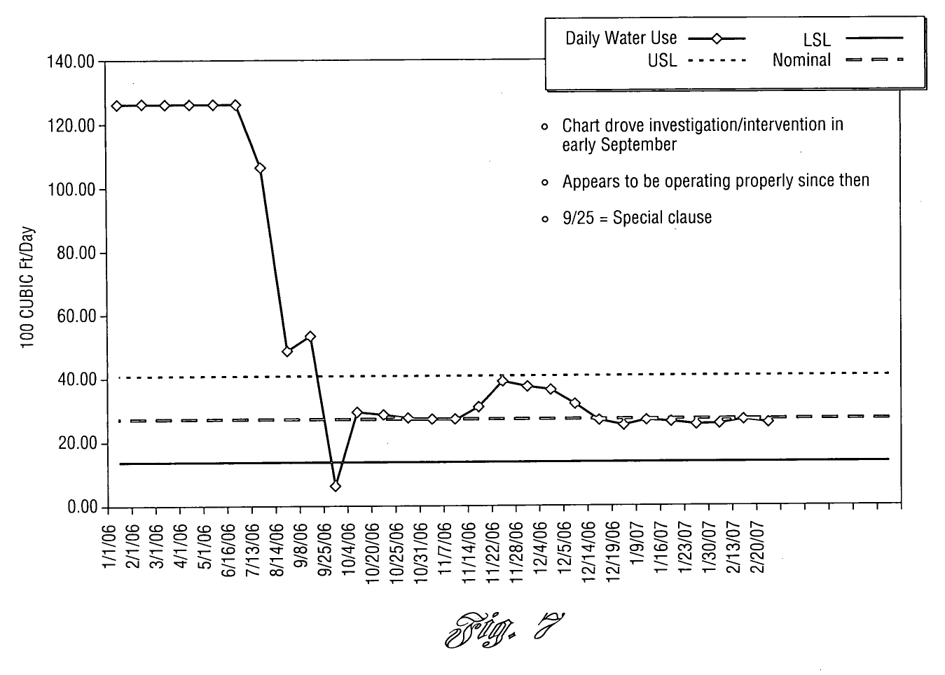

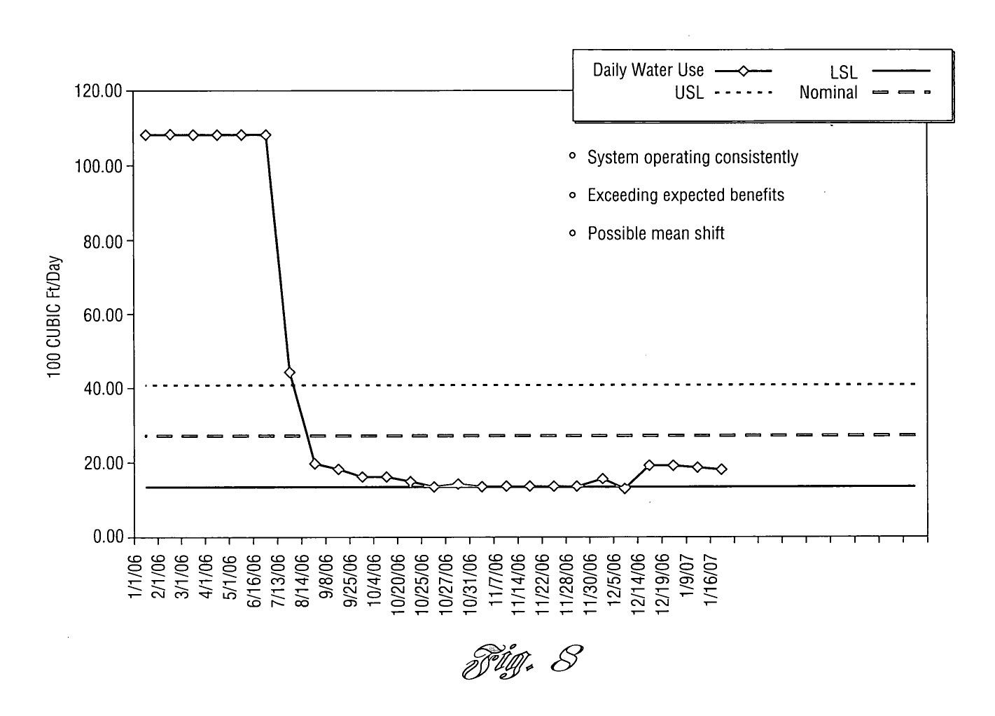

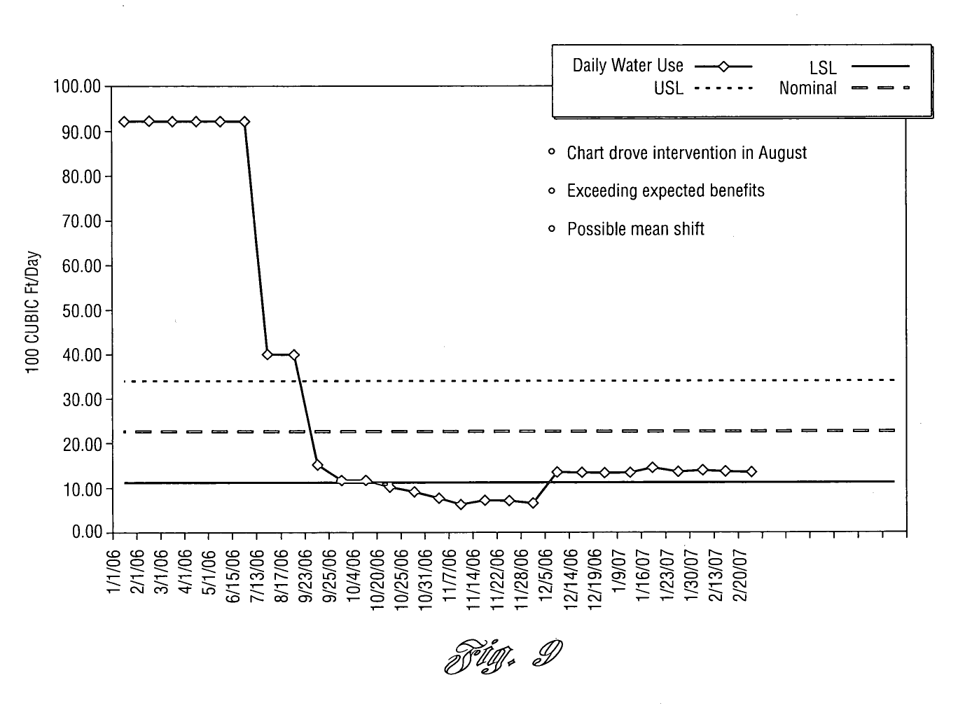

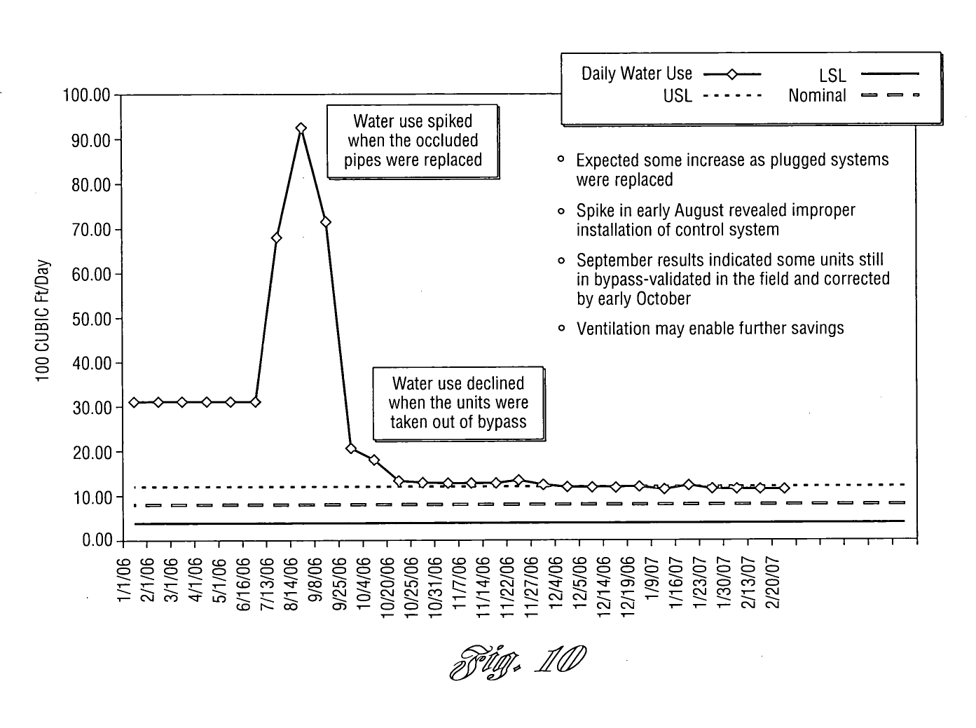

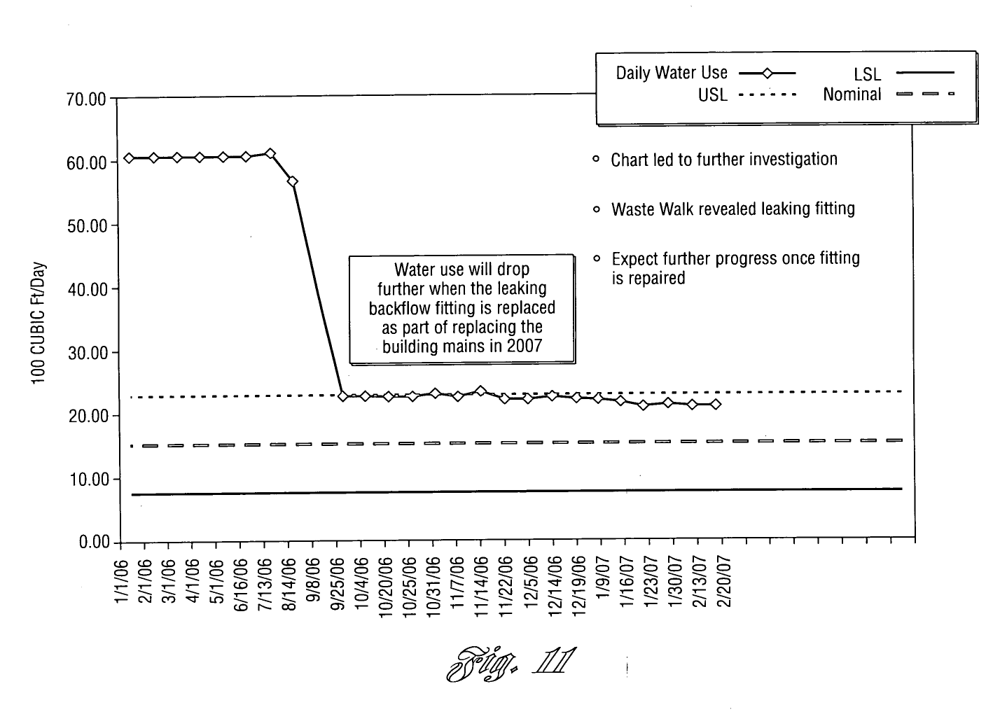

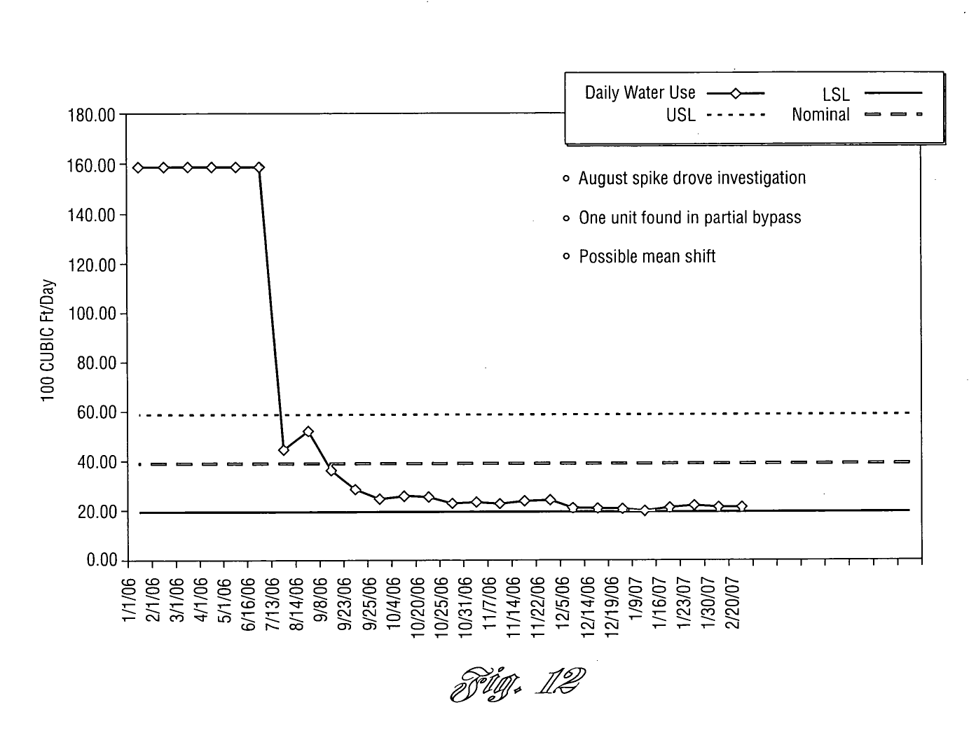

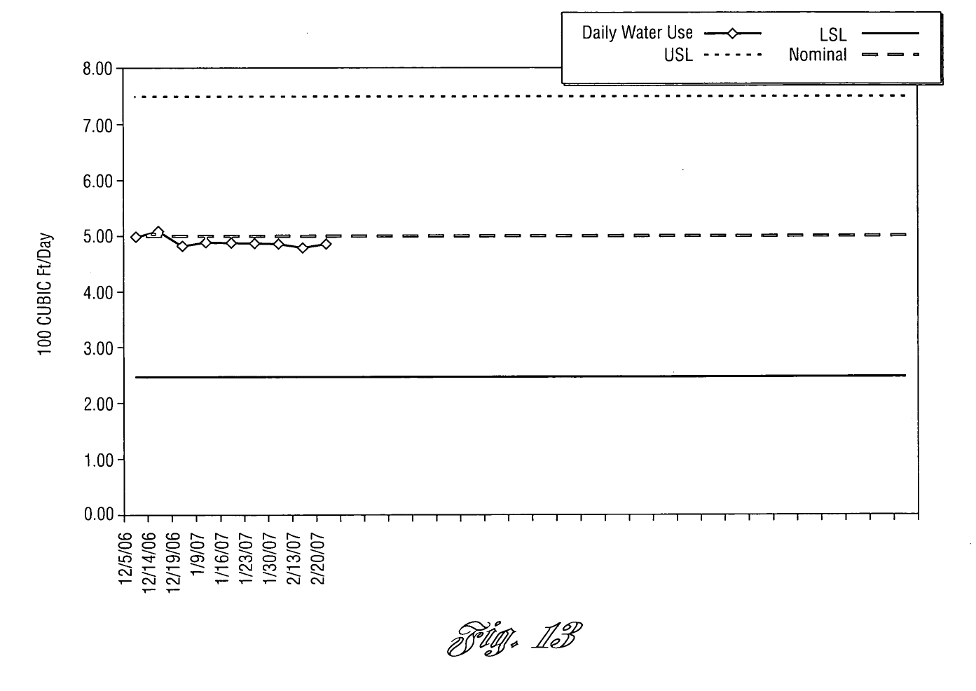

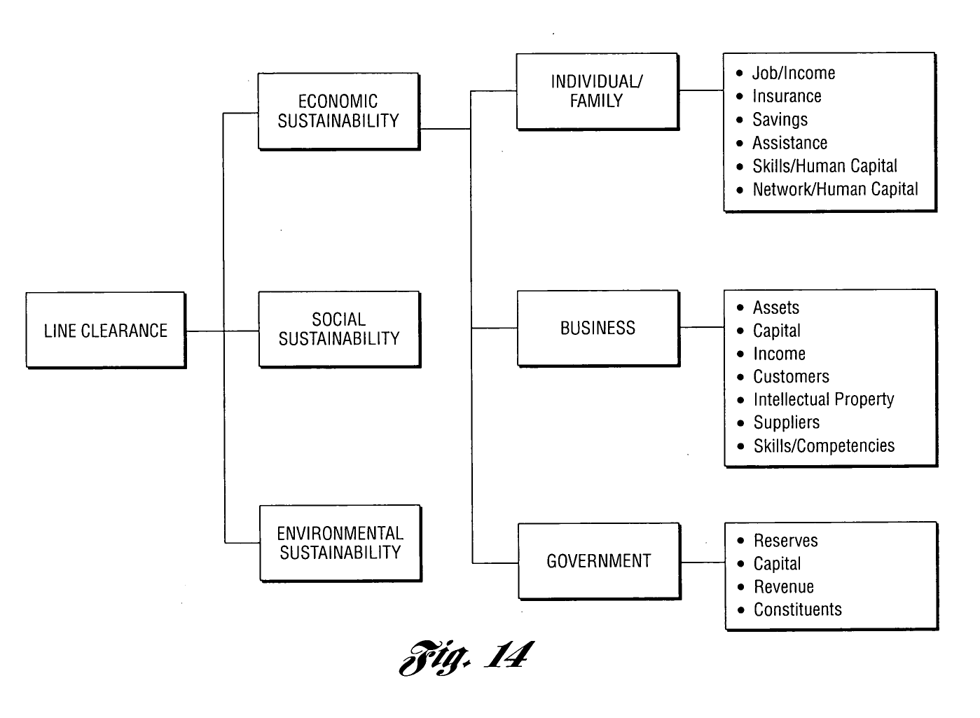

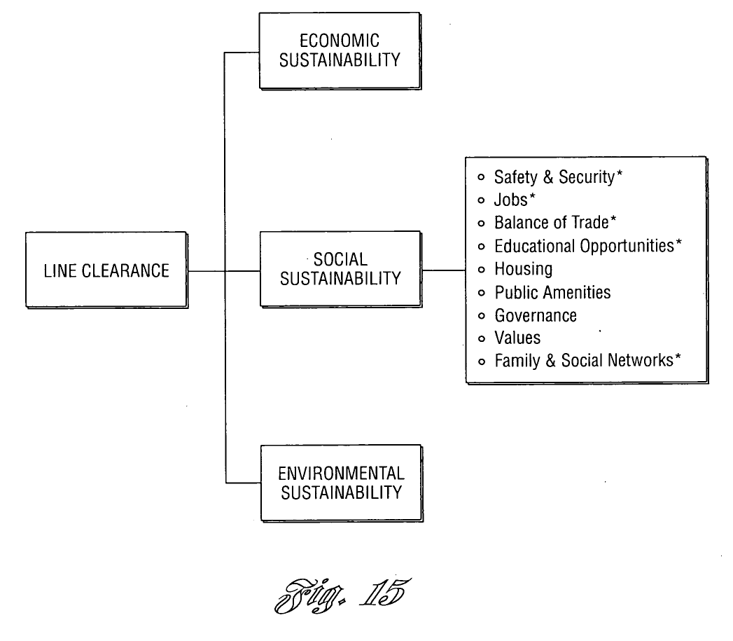

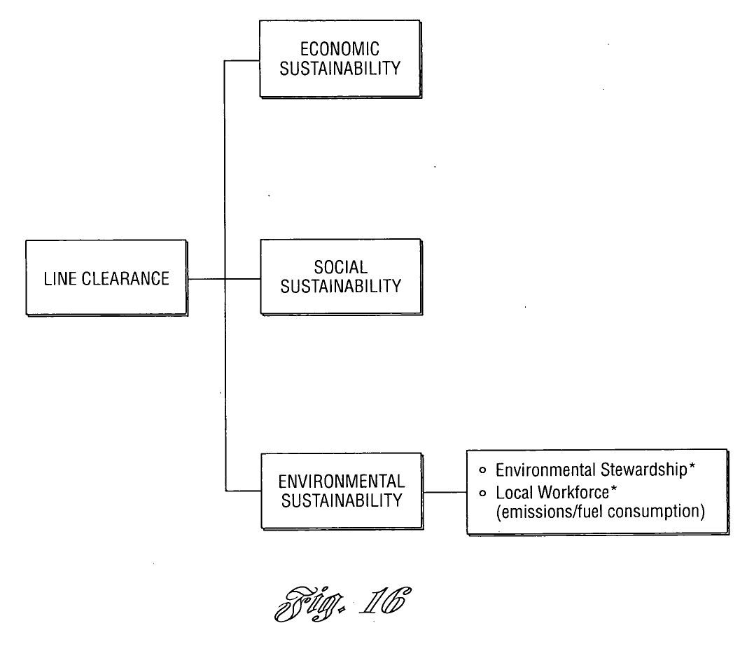

Gate 2 of FIG. 3 includes steps 4, 5 and 6 to determine: the solution to the problem and how much improvement one obtains. In step 4 one defines a desired outcome/ideal state. One fundamental Sustainable Lean Sigma tool is the Critical to Sustainability (CTS) tree which can be used in step 4. This tool follows the same structure as the Critical-to-Cost and Critical-to-Quality tree tools used in Lean Six Sigma. The CTS tree re-frames the question of what constitutes value and who is the customer. The customer may include:
Buyer
Employees
Community (social context)
Physical/biological environment (natural world context).
   The CTS tree synthesizes and integrates concerns and issues from each of the Triple Bottom Lines into a single framework. FIG. 6 shows just one branch of a CTS tree which may be used in a project focused on economic/environmental sustainability; FIGS. 14-16 show a more complete CTS tree used in an economic/social sustainability project noted hereinbelow.

The following are LSS concepts, methods, and tools that may be employed in step 4:
Voice of the Customer
Benchmarking
Business Plan
Ideal State Workshops
One piece flow
SMED/Setup Time Reduction.

The following are additional SLS concepts, methods, and tools that can be employed in step 4:
Voice of the Environment
Voice of the Community
Sustainability Vision/True North
Community Vision/True North
Aspirations Exercise (Dream Garden)
World Café
Presencing/U Process
Biomimicry
Future State Maps: Transportation, MEP Process Flow, BEC Interactional Dynamics Map
Waste=Food
Industrial Ecology
Value As Services Business Model
Design for the Environment
Design for Disassembly
Ecological Footprint Analysis
End-Use Resource Efficiency
Constraint Release Analysis
Tunneling Opportunity Analysis
3BL Kano Model
Values-Based Marketing
Appreciative Inquiry
Aspirational Motivation
Cradle to Cradle
Critical-to-Sustainability Tree
Reflection
Sustainability
Sustainable Lean Sigma
Triple Bottom Line

In step 5 of gate 2, project gaps and countermeasures are identified. A Failure Modes Effects Analysis (FMEA) is a fundamental LSS tool used to understand how a system, process, or product can fail, the effects of those failures, and their potential causes. The FMEA tool quantifies the significance of the failure modes based on the severity of the failure, its probability of occurrence, and the non-detectability of impending failure. It also identifies recommended countermeasures.

In SLS, the traditional FMEA is often expanded to include social and environmental failure modes (e.g., the chance that a waste disposal site used by an organization will fail to contain hazardous waste).

The following are LSS concepts, methods, and tools that can be used in step 5:
Error Proofing
Ideal State Map
Gap Analysis
Statistical tools (run charts, check sheets, histograms, hypothesis testing, regression analysis, reliability analysis, process capability/variation analysis, ANOVA, Design of Experiments, etc.)
Pull
Kanban
FMEA
SMED/Setup Timie Reduction
Visual Management
5S
Risk Analysis.

The following are SLS concepts, methods, and tools that can be used in step 5:
Excitatory/Inhibitory Pairs
Homeostasis
Extended FMEA
Crowd-Sourcing
Entropy Risk Assessment
Sustainability
Sustainable Lean Sigma
Triple Bottom Line.

Step 6 of gate 2 provides for a plan for implementation and a plan for sustaining. A typical Lean Six Sigma Implementation Plan would focus on the implementation of the future state process. In Sustainable Lean Sigma, as much or more emphasis would be placed on the Sustaining Plan, which would focus on specific tasks and actions to assure that the project's economic, societal, and environmental gains are sustained. The SLS Sustaining Plan typically is based on a FMEA.

The following are LSS concepts, methods, and tools that can be employed in step 6:
Decision Analysis Matrix
Master Planning Chart
Project Management tools (Critical Path Management, PERT, Earned Value Analysis, etc.)
Change Management
RASI/RACI Matrix
Risk Analysis.

The following are SLS concepts, methods, and tools that can be employed in step 6:
Transition/Stabilization Plan
Sustaining Plan
Sustainability
Sustainable Lean Sigma
Triple Bottom Line.

Gate 3 includes step 7 (Implementation). Some characteristics of step 7 that are common to Lean Six Sigma projects are:
Rapid feedback cycle
Adjust plans as needed, sometimes daily
Intensive emphasis on communication up, down, and across
Manage aggressively to the schedule
   In Sustainable Lean Sigma, the same approach to project management is taken, but the emphasis on sustainability principles can change the way project teams respond to emergent issues. As problems and issues arise during the project, the sustainability focus may lead to adoption of different corrective actions that longer-term reliability or other outcomes that are superior from a Triple Bottom Line perspective.

The following are LSS concepts, methods, and tools which may be used in step 7:
Pilot testing
Change Management Process
After Action Reviews
Rapid Experimentation.

The following are SLS concepts, methods, and tools which may be utilized in step 7:
Genetic Algorithms
Directed Mutation (parallel Kaizens)
Extended After Action Review (AAR)
Community participation
New Opportunity Assessment
Reflection
Sustainability
Sustainable Lean Sigma
Triple Bottom Line.

Gate 4 of FIG. 3 addresses the issue of how one sustains the change obtained by gate 3. Gate 4 includes steps 8 and 9.

Step 8 involves measuring project progress and sustaining the goals.

The following LSS concepts, methods, and tools may be used in step 8:
Customer Satisfaction
Standard Work Instructions
Control Point Audits
4-Blocks
Check Sheets
Run Charts/Control Charts
Hypothesis testing
Time Reduction Analysis
Cost Reduction Analysis
Visual Management
Balanced Scorecard.

The following SLS concepts, methods, and tools may be used in step 8:
Energy Consumption Analysis
Mass Consumption Analysis
Integrated Toxicity Burden Analysis
Ecological Footprint Analysis
Community Capability Assessment
Community Sustainability Assessment
Community Current Account and Balance of Trade Analysis
Community Resource Dependency Analysis
Socially Responsible Investing (SRI) Scorecard
Corporate Sustainability Report
Sustainability
Sustainable Lean Sigma
Triple Bottom Line.

In step 9, the team is acknowledged, time is provided for reflection and the results are communicated. The following may be provided:
Periodic updates on trends and savings
Written appreciation and acknowledgment of contribution
Awards, recognition, and/or tangible rewards for team members.

Step 9 summarizes results of the project, including environmental and social benefits as well as economic ones.

The following LSS concepts, methods, and tools may be included in step 9:
AAR
Balanced Scorecard
Celebration
Organizational Awards
Internal/External publications and publicity.

The following SLS concepts, methods, and tools may be included in step 9:
Socially Responsible Investing (SRI) Scorecard
Corporate Sustainability Report
Replication/Reproduction
Aspirations Exercise (Dream Garden)
Appreciative Inquiry
Extended After Action Review (AAR)
Reflection
Sustainability
Sustainable Lean Sigma
Triple Bottom Line.

An SLS case study or example involved a project to reduce water use in the Assignee's electricity distribution substations. Throughout the project, the mental model of Triple-Bottom-Line sustainability helped guide decisions, while Lean Six Sigma tools helped translate these concepts into tangible actions.
A Pareto Analysis of water use revealed that 7 of Assignee's 670 electricity distribution substations accounted for 80% of its substation water use. These locations were equipped with once-through cooling systems for critical equipment. The systems' temperature modulation was not functional, resulting in maximum water flow.
A Cause-and-Effect Diagram helped illustrate the root causes of high water use.
A Critical-to-Sustainability Tree was developed to identify the design and operational aspects of the water saver systems that were most important to sustaining the gains.
A Failure Modes and Effects Analysis was conducted to identify the possible ways in which the water saver systems could fail. Specific countermeasures to address those vulnerabilities were devised.
Control Charts are being used to monitor average daily water use and have already helped identify other defects in water systems.

The sustainability portion of the SLS framework offered its own set of benefits to the project. The focus on resource efficiency as an alternative to headcount reductions generated enthusiastic participation by field personnel. The Assignee chose plumbing materials that were more expensive initially but offered improved durability and opted to convert other functional plumbing systems to these more durable designs. Inspired by industrial ecology and resource conservation concepts, Assignee is pursuing heat recovery from the systems' hot waste water for use in neighboring businesses and greater use of passive cooling and active ventilation to further reduce water use.

The project took less than six months to fully implement. It is projected to reduce water use by 19 million cubic feet and yield annual savings of $700,000 without impacting labor costs. It has reduced the need for the Detroit Water and Sewerage Department to expand capacity at a time when doing so would be economically and politically difficult.

In the water savers project, the following were done with respect to step 1:
Identified opportunity from substation personnel (tribal knowledge)
Reviewed historical water usage and bills
Estimated savings from functional water saver systems.

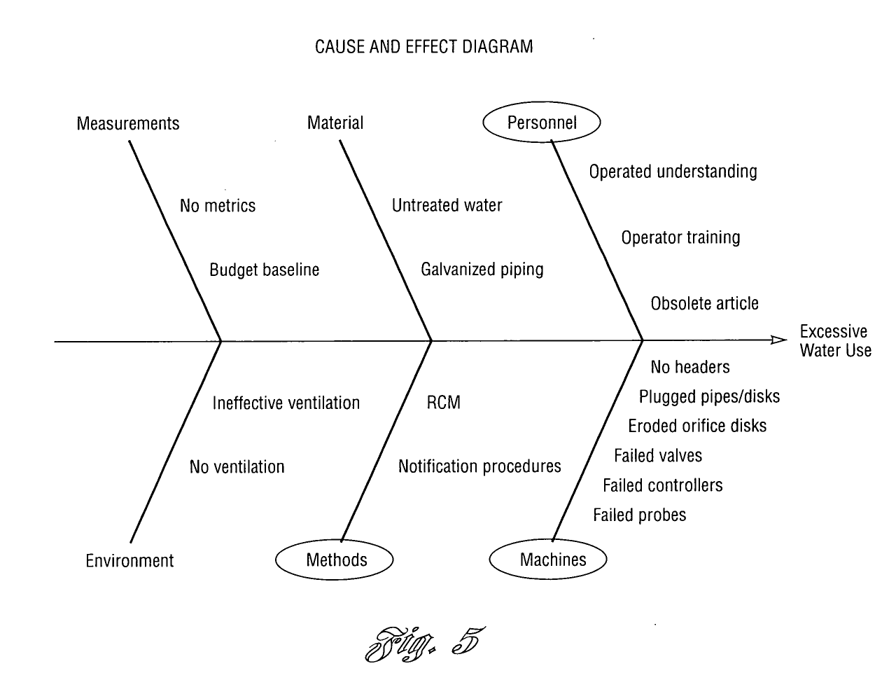

In step 2, a cross-functional, cross-organizational, multi-level, cross-disciplinary team was formed. Also, in step 2, the scope of the project was refined with the aid of the Pareto Analysis chart of FIG. 4. The Pareto Analysis chart showed that almost 90% of substation water use took place at 1% (7 of 660+) substations. This analysis helped narrow focus and simplify the project. It also helped identify the root cause(s) of high water use by determining what was common across these facilities.

In step 3, the team verified high water use and high water costs and investigated varied perspectives on the reasons for high water usage by going into the field to see what was actually happening at the point of activity. A more systemic and multi-faceted set of problems than was believed to exist was discovered.

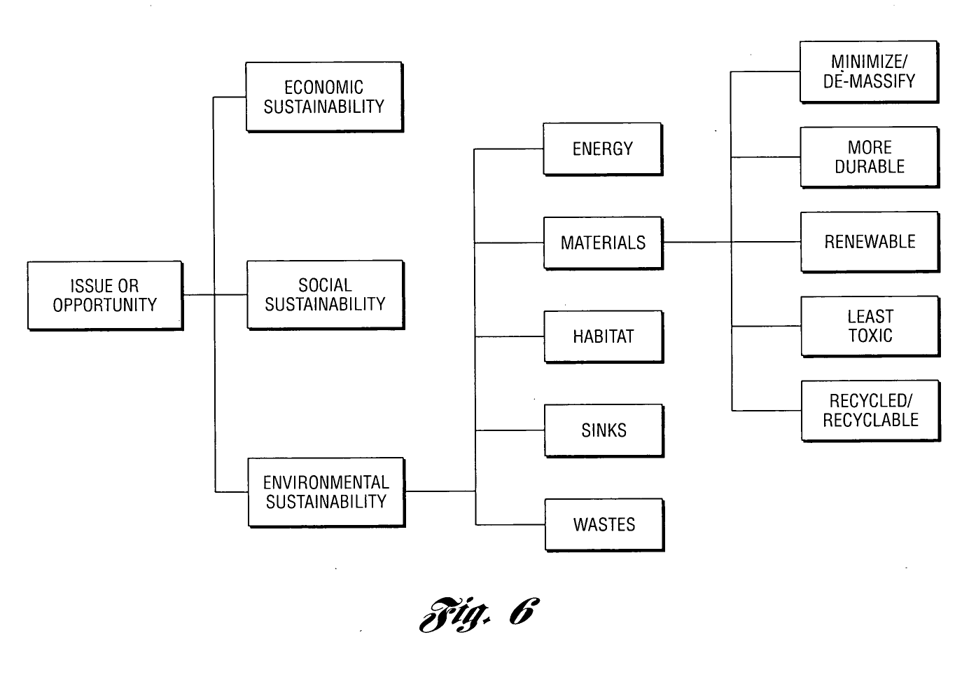

In this step, the Cause and Effect (i.e., Fishbone) diagram (a classic LSS tool) of FIG. 5 was developed.

In step 4, a Critical-to-Sustainability tree was constructed to understand the opportunities to achieve Triple Bottom Line benefits and identify sustainability leverage points.

In step 5, the team developed a Failure Modes-Effects Analysis (FMEA) to understand the reasons why its water cooling systems were not operating optimally and develop countermeasures to assure that the process and equipment changes being implemented would be sustained. Table 1 shows the FMEA developed in step 5.

TABLE 1

| Process | Key Process | Potential Failure | Potential Failure | | |
|---|---|---|---|---|---|
| Step | Input | Mode | Effects | SEV | Potential Causes |
| Repair | Corrective | No action | CAP not | 10 | Unclear |
| system | Action Plan | Deviation from | implemented | | responsibilities |
| | | plan | Ineffective CAP | | No funding |
| | | Improper plan | implementation | | Not a priority for |
| | | execution | | | EMJs |
| | | | | | No followup |
| | | | | | Inadequate |
| | | | | | oversight |
| | | | | | Inadequate |
| | | | | | training/explanation |
| | | | | | Inadequate QC |
| Train | Written Article | Article not read | System manually | 5 | Absences from |
| personnel | Trainer time | Article not | placed in bypass | | training |
| | | understood | mode | | Failure to read |
| | | Reversion to past | | | Article |
| | | practice | | | Failure to |
| | | | | | understand Article |
| | | | | | Resistance to new |
| | | | | | procedures |
| Monitor | Station alarms | System in bypass | System in bypass - | 10 | Improper alarms |
| operations | Water bills | mode - alarm | high water bills | | configuration |
| | | sounds | Water saver | | Malfunctioning |
| | | System in bypass | component failure | | alarm |
| | | mode - alarm does | from excess heat | | Control panel |
| | | not sound | Transformer failure | | failure |
| | | Excess outlet | from excess heat | | Temperature probe |
| | | temperature | | | failure |
| | | | | | Water saver system |
| | | | | | failure (flow) |
| Conduct | Maintenance plan | System in bypass | System in bypass - | 3 | Improper execution |
| Preventive | EMJs | mode - alarm | high water bills | | Inaccurate SWIs |
| Maintenance | | sounds | System component | | Inadequate |
| | | System in bypass | failure due to excess | | education & training |
| | | mode - alarm does | heat | | |
| | | not sound | Transformer failure | | |
| | | Excess outlet | due to excess heat | | |
| | | temperature | | | |

| Process | | Current | | | |
|---|---|---|---|---|---|
| Step | OCC | Controls | DET | RPN | Actions Recommended |
| Repair | 6 | MTS | 3 | 180 | Project team followup |
| system | | Project team | | | EPPM to certify repairs as |
| | | followup | | | specified |
| | | | | | Inspect all water saver systems for |
| | | | | | proper operation before summer |
| | | | | | peak |
| | | | | | Test all control panels before |
| | | | | | summer peak |
| Train | 6 | Written | 5 | 150 | Require all operators & |
| personnel | | Article | | | supervisors to review Article |
| | | Supervisor | | | Require sign-in for review sessions |
| | | reinforcement | | | Include a quiz |
| | | GS | | | Monitor attendance |
| | | reinforcement | | | |
| Monitor | 2 | Water bill | 4 | 80 | Install flow meters; |
| operations | | monitoring | | | connect to alarms |
| | | | | | EPPM to certify station alarm |
| | | | | | configuration |
| | | | | | Test station alarms |
| | | | | | Assure appropriate fail-safe |
| | | | | | performance |
| | | | | | Review water bills regularly |
| Conduct | 8 | SWIs | 3 | 72 | Periodic system audits |
| Preventive | | Metrics charts | | | Greater automation of chart |
| Maintenance | | display owner | | | updates |
| | | and update date | | | |
| | | Automatic | | | |
| | | chart range | | | |
| | | updates | | | |

The sustainability framework inherent in SLS led the project team to ask “what are we seeing in the field that isn't sustainable?” This framework uncovered numerous weaknesses in the infrastructure that needed to be fixed to avoid major disruptions and damage to the company's asset base.
At the Walker substation, longstanding drainage issues were corrected.
At the Grand River substation, the team replaced building mains that were discovered to be on the verge of failure.
At the Frisbie substation, inappropriate building main materials were replaced and previously-unknown water leaks were identified and repaired.
At the Scotten substation, plugged pipes that had created the risk of equipment damage from insufficient cooling were replaced.
At the Madison station, the team identified and corrected a risk of equipment failure from plugged pipes and a failing backflow fitting.

The framework also drove the project's approach to resolving billing issues with the Detroit Water and Sewerage Department, resulting in win-win outcomes and unexpected benefits to both parties.
DTE secured billing adjustments based on meter calibration tests (˜$500 k)
DTE and DWSD were able to implement technology for DWSD to read its meters without needing access to DTE substations, freeing up DTE operators, eliminating missed appointments, and stabilizing month-to-month water bills by eliminating estimated bills and billing catch-ups
Improved company infrastructure

The Assignee has undertaken other projects utilizing at least some of the above-noted steps. One such project is targeted at reducing vehicle fuel and maintenance costs. An SLS Waste Walk in vehicle fleet operations area led to asking questions about energy waste associated with letting motor vehicles idle. Internal marketing of the project emphasized financial and environmental benefits. In addition to the dollar savings, there is a substantial environmental benefit from elimination of excess idling. New idling guidelines can reduce CO₂ emissions.

As another example, and with reference to FIGS. 14-16, an electrical line clearance project has been undertaken to do the following:
Create a partnership that builds sustainability in the Metro Detroit Area and increases resource available to the Line Clearance Program
Increase the local qualified line clearance workforce pool for Assignee and other are businesses
Lower costs for line clearance
Create local jobs, at sustainable wages, thereby reducing dependency on “foreign” crews
Foster safer local communities with lower recidivism
Contribute to a viable alternative to the destructive cycles of a revolving-door prison and jail system
Increase safety and livability of service areas.

In this projects, the SLS framework and tool set have been utilized to achieve better results at lower cost by identifying and leveraging ecosystem and community resources and opportunities, anticipating and preventing implementation problems, and executing the project more effectively.

### GLOSSARY AND INDEX OF TERMS

| Heritage | Steps | Term | Acronym | Definition/Description |
|---|---|---|---|---|
| LSS | 1, 4 | Voice of the Customer | | The practice of ensuring that the |
| | | | | concerns of the ultimate |
| | | | | purchaser and/or user of a |
| | | | | product or service are |
| | | | | represented and given |
| | | | | appropriate consideration when |
| | | | | decisions are being made. |
| SLS | 1, 3, 4 | 3BL Kano Model | | The traditional Kano Model is a |
| | | | | LSS tool used to analyze and |
| | | | | understand known and latent |
| | | | | customer requirements or |
| | | | | preferences. The Triple Bottom |
| | | | | Line Kano Model goes beyond |
| | | | | the traditional Kano Model's |
| | | | | focus on direct customer |
| | | | | experience with the product or |
| | | | | service to evaluate customer |
| | | | | preferences in terms of the |
| | | | | product or service's ecological |
| | | | | or societal impacts, the values |
| | | | | that the product or service is |
| | | | | perceived to embody or express, |
| | | | | and the company's broader |
| | | | | economic, societal, and |
| | | | | environmental impact and |
| | | | | behavior (actual and perceived). |
| | | | | It considers these broader |
| | | | | considerations from the |
| | | | | perspective of both customers |
| | | | | (current and potential) and non- |
| | | | | customer stakeholders (e.g., |
| | | | | citizens, regulators, non- |
| | | | | governmental organizations, |
| | | | | financial rating firms). To the |
| | | | | extent that repuational factors |
| | | | | affect a company's valuation |
| | | | | ratios, the 3BL Kano Model |
| | | | | offers a way to link product and |
| | | | | operational attributes to strategic |
| | | | | and financial priorities. It is |
| | | | | often used in conjunction with |
| | | | | values-based marketing. |
| SLS | 3 | 5M + E³ Fishbone | | Cause-effect diagram that |
| | | Diagram | | examines a problem or defect. It |
| | | | | differs from the traditional |
| | | | | 5M + E framework by adding |
| | | | | Ecology and Energy. |
| SLS | 4, 9 | Appreciative Inquiry | | An organizational development |
| | | | | process or philosophy that |
| | | | | engages individuals within an |
| | | | | organizational system in its |
| | | | | renewal, change and focused |
| | | | | performance. Appreciative |
| | | | | Inquiry was developed by David |
| | | | | Cooperrider of Case Western |
| | | | | Reserve University. It is now a |
| | | | | commonly accepted practice in |
| | | | | the evaluation of organizational |
| | | | | development strategy and |
| | | | | implementation of organizational |
| | | | | effectiveness tactics. |
| | | | | Appreciative Inquiry is a |
| | | | | particular way of asking |
| | | | | questions and envisioning the |
| | | | | future that fosters positive |
| | | | | relationships and builds on the |
| | | | | basic goodness in a person, a |
| | | | | situation, or an organization. In |
| | | | | so doing, it enhances a system's |
| | | | | capacity for collaboration and |
| | | | | change. |
| SLS | 1, 4 | Aspirational Motivation | | An SLS tool to more fully |
| | | | | realize human potential by |
| | | | | tapping into the aspirations of the |
| | | | | members of a group, |
| | | | | organization, or community. |
| | | | | Fundamental to this tool are a set |
| | | | | of structured activities and |
| | | | | processes that facilitate the |
| | | | | identification and expression of |
| | | | | aspirations. |
| SLS | 1, 4, 9 | Aspirations Exercise | | Exercise in which participants |
| | | (Dream Garden) | | articulate their aspirations for the |
| | | | | organization or community |
| | | | | through structured visioning |
| | | | | and/or hands-on activities. For |
| | | | | example, the Dream Garden |
| | | | | exercise engages participants in |
| | | | | gardening activities in which the |
| | | | | plants represent individuals' |
| | | | | vision for their roles and the |
| | | | | entire garden represents the |
| | | | | individual and collective vision |
| | | | | for the larger entity. This |
| | | | | practice is used as a reflection of |
| | | | | exercise that allows for |
| | | | | collective intentions to arise |
| | | | | from the whole. |
| SLS | 3 | Business-Environment- | BEC Map | Diagram showing the causal |
| | | Community Interactional | | loops within and between the |
| | | Dynamics Map | | business, community, and |
| | | | | environmental sectors. |
| SLS | 4 | Biomimicry | | The practice of looking to nature |
| | | | | as model and mentor to solve |
| | | | | problems. For example: |
| | | | | understanding how aquatic |
| | | | | organisms manage to prevent |
| | | | | mineral deposition can help |
| | | | | power plant operators understand |
| | | | | how to prevent scale buildup |
| | | | | more effectively and at lower |
| | | | | cost. (Janine Benyus) |
| SLS | 3 | Cap-4 Analysis | | Evaluation of the return on |
| | | | | invested capital from a SLS |
| | | | | perspective, in which there are 4 |
| | | | | types of capital: financial, |
| | | | | manufactured, human, and |
| | | | | natural. |
| SLS | 3 | Communities Connection | | Evaluation of the financial, |
| | | Analysis | | material, energy, and human |
| | | | | flows between communities. |
| | | | | Yields insights into the |
| | | | | community development |
| | | | | opportunities that may exist, |
| | | | | connections that can be deepened |
| | | | | or improved, and points of |
| | | | | vulnerability. |
| SLS | 1, 2 | Community Advisory | | A group of individuals connected |
| | | Board | | to the community that are |
| | | | | charged with bringing the Voice |
| | | | | of the Community into an |
| | | | | organization's decision-making |
| | | | | that may affect the communities |
| | | | | in which the organization is |
| | | | | located or is trying to impact. |
| | | | | The CAB is also charged with |
| | | | | identifying emerging |
| | | | | opportunities for the organization |
| | | | | and community to collaborate to |
| | | | | mutual benefit; making the |
| | | | | organization aware of significant |
| | | | | changes in the community, and |
| | | | | helping the organization better |
| | | | | understand the community. |
| SLS | 8 | Community Capability | | Formal evaluation of the |
| | | Assessment | | human, cultural, |
| | | | | physical/environmental, |
| | | | | financial, and manufactured |
| | | | | assets that a community |
| | | | | possesses, including skills, |
| | | | | resources, and capabilities. |
| SLS | 1 | Community Capability | | Physical or virtual tours of a |
| | | Walks | | community, location, or region |
| | | | | to identify its available |
| | | | | capabilities, infrastructure, |
| | | | | human resources, etc., with |
| | | | | particular emphasis on untapped |
| | | | | capabilities. |
| SLS | 3, 8 | Community Current | | Application of national income |
| | | Account and Balance of | | accounting tools to local |
| | | Trade Analysis | | communities. Input to |
| | | | | understanding a community's |
| | | | | source of wealth, identifying |
| | | | | import substitution opportunities, |
| | | | | and identifying export |
| | | | | opportunities. |
| SLS | 2 | Community Liaison | | An organizational member who |
| | | | | serves as a point of contact, 2- |
| | | | | way communication channel, and |
| | | | | go-between between a |
| | | | | community and the organization. |
| SLS | 8 | Community Resource | | Analysis that depicts the types of |
| | | Dependency Analysis | | resources from outside the |
| | | | | community on which the |
| | | | | community relies, the sources of |
| | | | | those resources, the vulnerability |
| | | | | of those sources and supply |
| | | | | chains to disruption, and the |
| | | | | ability of the community to do |
| | | | | without the resource, find |
| | | | | alternate sources, or switch to |
| | | | | substitutes. |
| SLS | 8 | Community | | Formal assessment of the extent |
| | | Sustainability | | to which a community's |
| | | Assessment | | economic, social, and |
| | | | | environmental behaviors, |
| | | | | practices, values, and structures |
| | | | | promote or jeopardize the ability |
| | | | | of the community to thrive for |
| | | | | all time. |
| SLS | 4 | Community Vision/True | | A community's unifying purpose |
| | | North | | and future direction that provides |
| | | | | a ‘True North’ for the |
| | | | | community's evolution and |
| | | | | development. ‘True North’ is a |
| | | | | normative LSS concept that goes |
| | | | | beyond vision and mission |
| | | | | statements to provide a constant |
| | | | | direction for where the |
| | | | | organization needs to go. It |
| | | | | allows for action in the absence |
| | | | | of perfect information or clear |
| | | | | cost-benefit analysis and serves |
| | | | | to align the actions of numerous |
| | | | | individuals and groups without |
| | | | | formal controls. The |
| | | | | Community Vision/True North |
| | | | | represents the often-unspoken |
| | | | | consensus about what is desired, |
| | | | | what is acceptable, and what is |
| | | | | unacceptable. Communities with |
| | | | | a strong and coherent True |
| | | | | North are able to muster and |
| | | | | align a greater proportion of |
| | | | | their community assets and |
| | | | | resources in the service of their |
| | | | | vision than communities without |
| | | | | a coherent True North. |
| SLS | 4 | Constraint Release | | Analysis that identifies |
| | | Analysis | | constraints on a product, |
| | | | | process, community, or |
| | | | | organization and evaluates the |
| | | | | impact of removing one or more |
| | | | | constraints. See Tunneling |
| | | | | Analysis. |
| SLS | 8, 9 | Corporate Sustainability | | Publicly distributed report that |
| | | Report | | summarizes a company's |
| | | | | sustainability performance, |
| | | | | goals, and commitments. |
| | | | | Analogous to an organization's |
| | | | | annual report. |
| SLS | 1, 3 4 | Cradle to Cradle | | Design philosophy that aims to |
| | | | | assure that all of the materials |
| | | | | used in making a product |
| | | | | (including byproducts, |
| | | | | processing materials, and the |
| | | | | product itself at the end of its |
| | | | | useful life) end up incorporated |
| | | | | in another product or returned |
| | | | | unimpaired to the environment. |
| SLS | 2, 4 | Critical-to-Sustainability | CTS Tree | Diagram that translates triple |
| | | Tree | | bottom line requirements or |
| | | | | desired outcomes |
| | | | | (environmental, |
| | | | | social/community, and |
| | | | | economic/business) to |
| | | | | product/service attribute |
| | | | | requirements. It subsumes |
| | | | | Critical-to-Quality and Critical- |
| | | | | to-Cost trees in a more holistic |
| | | | | framework and brings a triple |
| | | | | bottom line perspective into |
| | | | | product/service design, process |
| | | | | design, and process |
| | | | | improvement efforts. |
| SLS | 5 | Crowd-Sourcing | | A method that allows for work |
| | | | | activities to be outsourced to |
| | | | | stakeholders (customers, |
| | | | | constituents, shareholders, |
| | | | | community, etc.) Tasks tend to |
| | | | | be a two levels - simple tasks |
| | | | | (i.e pattern recognition, |
| | | | | calculation) where these |
| | | | | stakeholders make little or no |
| | | | | income as a result of completing |
| | | | | the task - or complicated |
| | | | | problems where several |
| | | | | stakeholders work on a project |
| | | | | together for the benefit of the |
| | | | | organization. Crowd-sourcing is |
| | | | | a business method of leveraging |
| | | | | open-source infrastructure with |
| | | | | purpose driven stakeholders. |
| SLS | 4 | Design for Disassembly | | The practice of designing |
| | | | | products so that they can be |
| | | | | disassembled at the end of their |
| | | | | functional life to recover |
| | | | | components and materials, |
| | | | | facilitate recycling, and |
| | | | | minimize waste. See Waste = Food. |
| SLS | 4 | Design for the | | The practice of designing |
| | | Environment | | products to minimize their |
| | | | | environmental impact during |
| | | | | manufacture, use, and end-of- |
| | | | | life handling. See Waste = Food |
| | | | | and Ecological Footprint |
| | | | | Analysis. |
| SLS | 7 | Directed Mutation | | Directed Mutation is the practice |
| | | (parallel Kaizens) | | of inducing variation in a |
| | | | | population that is subject to |
| | | | | deliberate selection pressure, |
| | | | | selecting the “most fit” variants, |
| | | | | replicating them, and then |
| | | | | repeating the cycle. In SLS, it is |
| | | | | applied by generating process |
| | | | | variation via multiple parallel |
| | | | | Kaizens on the same process and |
| | | | | selecting the variant that |
| | | | | demonstrates the best |
| | | | | performance. |
| SLS | 1, 3, | Ecological Footprint | | Analysis that calculates the total |
| | 4, 8 | Analysis | | impact of a product, service, |
| | | | | business, organization, |
| | | | | community, or society, often |
| | | | | expressed in terms of the total |
| | | | | land area needed to supply the |
| | | | | energy, materials, food, and |
| | | | | other resources used by the |
| | | | | subject of the analysis. |
| SLS | 1 | Ecological/Societal Scan | | Practice of evaluating trends, |
| | | | | developments, emerging issues, |
| | | | | risk factors, and opportunities |
| | | | | for an organization arising from |
| | | | | the communities/societies and |
| | | | | ecosystems in which the |
| | | | | organization operates, draws on |
| | | | | for resources, or affects. |
| SLS | 3 | End-to-End (E2E) | | Calculation of the efficiency |
| | | Conversion Efficiency | | with which inputs are converted |
| | | | | to outputs through the entire |
| | | | | value chain. Example: Well-to- |
| | | | | Wheels conversion efficiency |
| | | | | calculates the percentage of |
| | | | | energy in an energy source that |
| | | | | is turned into motive power, |
| | | | | taking into account the energy |
| | | | | needed to extract, transport, |
| | | | | process, distribute, and convert |
| | | | | the energy. It is used to |
| | | | | compare the efficiency of, say, |
| | | | | hybrid gas-electric vehicles with |
| | | | | hypothetical fuel cell vehicles. |
| SLS | 4 | End-Use Resource | | Practice of identifying energy |
| | | Efficiency | | efficiency opportunities by |
| | | | | beginning at the point where the |
| | | | | energy is used or consumed, |
| | | | | rather than where it is produced. |
| | | | | This approach offers greater |
| | | | | leverage per unit of energy |
| | | | | conserved. |
| SLS | 8 | Energy Consumption | | Analysis that computes the |
| | | Analysis | | economic output of an |
| | | | | organization per unit of energy |
| | | | | purchased or used. Provides a |
| | | | | rough measure of an |
| | | | | organization's overall ecological |
| | | | | efficiency. |
| SLS | 5 | Entropy Risk | | In SLS, the formal assessment of |
| | | Assessment | | the points of vulnerability in the |
| | | | | proposed future state where |
| | | | | disorder can creep into the |
| | | | | system and the development of |
| | | | | countermeasures to prevent |
| | | | | disorder from growing. |
| SLS | 1, 2 | Environmental Advisory | | A group of individuals that are |
| | | Board | | charged with bringing the Voice |
| | | | | of the Environment into an |
| | | | | organization's decision-making |
| | | | | that may affect the ecosystems |
| | | | | which the organization affects or |
| | | | | is trying to affect. The EAB is |
| | | | | also charged with identifying |
| | | | | emerging environmental |
| | | | | concerns and issues; helping the |
| | | | | organization recognize business |
| | | | | opportunities related to |
| | | | | environmental factors; making |
| | | | | the organization aware of |
| | | | | significant changes in the |
| | | | | environment, and helping the |
| | | | | organization better understand |
| | | | | environmental issues, research, |
| | | | | and findings. |
| SLS | 5 | Excitatory/Inhibitory | | Biological concept that governs |
| | | Pairs | | many body processes, in which a |
| | | | | process is governed by the |
| | | | | balance between excitatory |
| | | | | signals and inhibitory signals. |
| | | | | Various feedback loops |
| | | | | constantly adjust the level of |
| | | | | each type of signal to achieve |
| | | | | rapid and precise control over |
| | | | | complex processes. In SLS, this |
| | | | | model is applied to govern |
| | | | | production and community |
| | | | | processes with far greater |
| | | | | precision than is possible |
| | | | | through the conventional method |
| | | | | of direct process forcing. |
| SLS | 7, 9 | Extended After Action | Extended | Extends the After Action Review |
| | | Review | AAR | to embrace the participation of |
| | | | | community members and/or |
| | | | | environmental experts or |
| | | | | advocates and to ask what new |
| | | | | opportunities the project or |
| | | | | action under review has created |
| | | | | or made visible. |
| SLS | 5 | Extended FMEA | | Extends the FMEA framework |
| | | | | to include environmental and |
| | | | | social/community failure modes, |
| | | | | effects, and detection. |
| SLS | 4 | Future State Maps: | | Versions of the Transformation, |
| | | Transformation, MEP | | MEP Process Flow, and BEC |
| | | Process Flow, BEC | | Interactional Dynamics diagrams |
| | | Interactional Dynamics | | that show the future state to be |
| | | Map | | implemented. |
| SLS | 7 | Genetic Algorithms | | Technique used to develop better |
| | | | | ways to solve problems through |
| | | | | directed mutation. Genetic |
| | | | | algorithm problem solving |
| | | | | includes agent based modeling |
| | | | | and the use of recursive |
| | | | | simulation to “evolve” a solution |
| | | | | from many trails in order to |
| | | | | optimize an objective function. |
| SLS | 5 | Homeostasis | | Principle that organisms function |
| | | | | so as to maintain their |
| | | | | metabolism and structure within |
| | | | | a narrow range of variation. In |
| | | | | SLS, this principle is used to |
| | | | | understand the forces that may |
| | | | | resist change and attempt to |
| | | | | return the organization, process, |
| | | | | or community to its current |
| | | | | (prior) state; it is also used to |
| | | | | design future states that can self- |
| | | | | sustain and self-maintain. |
| SLS | 4 | Industrial Ecology | | Discipline of viewing economic |
| | | | | entities using ecological |
| | | | | concepts, typically as part of an |
| | | | | ‘ecosystem’ in which economic |
| | | | | entities are or can be connected |
| | | | | by material and energy flows. |
| | | | | In SLS, this concept is extended |
| | | | | to encompass financial and |
| | | | | human resource flows; to |
| | | | | evaluate the ways in which |
| | | | | businesses compete for physical, |
| | | | | financial, and human resources; |
| | | | | and to view the business |
| | | | | landscape as an array of |
| | | | | differentiated niches, the |
| | | | | characteristics of which |
| | | | | influence the types of business |
| | | | | strategies that can succeed. See |
| | | | | Waste = Food. |
| SLS | 8 | Integrated Toxicity | | Analysis that combines the |
| | | Burden Analysis | | toxicity impacts of different |
| | | | | input, production, and output |
| | | | | compounds to understand the |
| | | | | overall toxicity burden of a given |
| | | | | product and production process. |
| | | | | The analysis can be applied to |
| | | | | workers (industrial hygiene and |
| | | | | safety), customers, the general |
| | | | | public, or the ecosystem. |
| | | | | Analyses of different |
| | | | | product/process combinations |
| | | | | can be used to identify lower- |
| | | | | toxicity options. |
| SLS | 3 | Life Cycle Analysis | | Analysis that evaluates |
| | | | | environmental impacts over the |
| | | | | entire life cycle of a product, |
| | | | | service, or process, including its |
| | | | | production, use, and disposal. |
| | | | | For example, life cycle analyses |
| | | | | of the carbon dioxide impact of |
| | | | | corn-based ethanol would |
| | | | | consider the carbon dioxide |
| | | | | emitted in growing and |
| | | | | harvesting the corn (including |
| | | | | emissions from tilling the soil), |
| | | | | making fertilizer, transporting |
| | | | | the corn to the ethanol facility, |
| | | | | converting corn to ethanol, |
| | | | | disposing of ethanol production |
| | | | | byproducts, transporting ethanol |
| | | | | to end users, blending ethanol |
| | | | | with gasoline, and burning |
| | | | | ethanol to generate power, the |
| | | | | carbon dioxide removed from |
| | | | | the air by the corn plants, and |
| | | | | the carbon dioxide not emitted |
| | | | | due to displacement of gasoline |
| | | | | by ethanol. |
| SLS | 3 | Limiting Factor Analysis | | Ecological concept that looks at |
| | | | | the input which controls the rate |
| | | | | of growth of an organism or |
| | | | | population. It has been modified |
| | | | | and extended in SLS to focus on |
| | | | | the physical, cultural/social, and |
| | | | | production factors that limit an |
| | | | | organization's or community's |
| | | | | ability to grow, develop, thrive, |
| | | | | or perform. |
| SLS | 8 | Mass Consumption | | Analysis that computes the |
| | | Analysis | | economic output of an |
| | | | | organization per ton of inputs |
| | | | | purchased, extracted, moved, |
| | | | | transformed, or used. Provides |
| | | | | a rough measure of an |
| | | | | organization's overall ecological |
| | | | | efficiency. |
| SLS | 1, 3 | Mass-Energy-Process | MEP | Diagram of a process (typically a |
| | | Flow Diagrams | Flow | production or service process) |
| | | | Diagrams | that shows the work steps, |
| | | | | material flows, and energy flows |
| | | | | on a single diagram. MEP Flow |
| | | | | Diagrams can be developed at a |
| | | | | variety of levels of detail. They |
| | | | | are typically more detailed than |
| | | | | Transformation Maps and are |
| | | | | generally used to simplify |
| | | | | production processes and |
| | | | | minimize environmental impacts |
| | | | | within the four walls of an |
| | | | | organization. See |
| | | | | Transformation Map. |
| SLS | 1 | Natural Resource Walks | | Physical or virtual tours of a |
| | | | | community, location, or region |
| | | | | to identify the available natural |
| | | | | resources. |
| SLS | 4 | Presencing/U Process | | Process pioneered by Otto |
| | | | | Scharmer to shift the inner place |
| | | | | from which individuals and |
| | | | | groups function to allow new |
| | | | | possibilities to emerge. Used in |
| | | | | SLS to develop future visions for |
| | | | | organizations and communities. |
| SLS | 3 | Product: Service Flow | | Diagram that shows the product |
| | | Conversion Map | | as used by the purchaser and/or |
| | | | | end user in terms of the services |
| | | | | provided over time. Used to |
| | | | | identify opportunities to convert |
| | | | | products into flows of services. |
| SLS | 1 | Extended Project | | Analytic tool, typically |
| | | Selection Matrix | | computerized, that is used to |
| | | | | determine which projects are |
| | | | | most promising based on an |
| | | | | extended set of criteria that |
| | | | | embody Triple Bottom Line |
| | | | | considerations. Integrates |
| | | | | economic, social, environmental, |
| | | | | and feasiblity/risk considerations |
| | | | | in the project selection process. |
| SLS | 1, 4, | Reflection | | Discipline of stepping back from |
| | 7, 9 | | | day-to-day action to examine |
| | | | | what has been learned, what is |
| | | | | working that should be retained, |
| | | | | and what needs to be changed. |
| | | | | In SLS, reflection is a |
| | | | | fundamental practice that |
| | | | | operates on the individual and |
| | | | | group level. |
| SLS | 9 | Replication/ | | In SLS, the disciplined, |
| | | Reproduction | | structured process by which |
| | | | | successful experiments and |
| | | | | projects are replicated, expanded |
| | | | | in size, or increased in number, |
| | | | | modeled after the three main |
| | | | | methods of growth in biology. |
| SLS | 1 | Scenario Planning | | A strategic planning exercise in |
| | | | | which an organization evaluates |
| | | | | the probability that its default or |
| | | | | baseline model of the future is |
| | | | | reasonable by asking what has to |
| | | | | be true and what has to happen - |
| | | | | environmentally, socially, and |
| | | | | economically - for it to be valid. |
| | | | | This tool helps facilitate the |
| | | | | “letting go” phase of the U |
| | | | | Process, opens the strategic |
| | | | | planning dialogue to the |
| | | | | possibility of |
| | | | | unconventional/unexpected |
| | | | | futures, and helps inculcate a |
| | | | | probabilistic approach to |
| | | | | business planning in place of the |
| | | | | traditional deterministic model. |
| SLS | 1, 2, 3 | SIPOC³ Model | | High-level mapping tool that |
| | | | | applies the SIPOC model to |
| | | | | three different perspectives of |
| | | | | ‘customer’ and ‘supplier’: the |
| | | | | conventional LSS definition, the |
| | | | | environment, and the community |
| | | | | or broader society. See SIPOC. |
| SLS | 1, 3 | SLS Waste Walks (12 | | Waste Walk that includes the 7 |
| | | SLS wastes) | | traditional Lean wastes and the 5 |
| | | | | additional SLS wastes: Energy, |
| | | | | Materials/mass, Ecosystem |
| | | | | Services, Community Resources, |
| | | | | and Human Potential. |
| SLS | 8, 9 | Socially Responsible | | Socially Responsible Investing |
| | | Investing (SRI) | | Scorecard. A set of metrics used |
| | | Scorecard | | by Socially Responsible |
| | | | | Investing fiduciaries and |
| | | | | investors to evaluate |
| | | | | corporate/organizational |
| | | | | performance. |
| SLS | All | Sustainability | | The ability of a system, process, |
| | | | | organization, community, or |
| | | | | society to exist in its current |
| | | | | state indefinitely, without |
| | | | | impairing the ability of other |
| | | | | systems, processes, |
| | | | | organizations, communities, or |
| | | | | societies to exist in their current |
| | | | | state. |
| SLS | 1, 3 | Sustainability Indicators | | Metrics and measures of the |
| | | | | extent to which an organization, |
| | | | | community, or society is |
| | | | | sustainable from a triple bottom |
| | | | | line perspective. |
| SLS | 4 | Sustainability | | A model for triple bottom line |
| | | Vision/True North | | sustainability that provides a |
| | | | | ‘True North’ for the |
| | | | | organization's sustainability |
| | | | | journey. ‘True North’ is a |
| | | | | normative LSS concept that goes |
| | | | | beyond vision and mission |
| | | | | statements to provide a constant |
| | | | | direction for where the |
| | | | | organization needs to go. It |
| | | | | allows for action in the absence |
| | | | | of perfect information or clear |
| | | | | cost-benefit analysis and serves |
| | | | | to align the actions of numerous |
| | | | | individuals and groups without |
| | | | | formal controls. It signals the |
| | | | | proper direction towards which |
| | | | | continuous improvement efforts |
| | | | | and organizational strategy |
| | | | | should be directed. |
| SLS | All | Sustainable Lean Sigma | SLS | Framework for improving triple |
| | | | | bottom line results through the |
| | | | | application and integration of |
| | | | | Lean Six Sigma, Social |
| | | | | Development, and |
| | | | | Environmental Sustainability |
| | | | | tools, models, frameworks, and |
| | | | | concepts. |
| SLS | 6 | Sustaining Plan | | Detailed action plan to assure |
| | | | | that improved performance is |
| | | | | sustained over time. |
| SLS | 3 | Transformation Map | | Diagram showing processes at a |
| | | (value/waste streams) | | high level, including major |
| | | | | production/transformation/ |
| | | | | value-adding stages, key |
| | | | | suppliers, customers, energy |
| | | | | flows, material flows, and |
| | | | | information flows. Unlike a |
| | | | | Value Stream Map, a |
| | | | | Transformation Map shows |
| | | | | natural resource inputs and waste |
| | | | | streams as an integral part of the |
| | | | | process of transforming inputs to |
| | | | | outputs. Transformation Maps |
| | | | | show the connections between |
| | | | | production processes and |
| | | | | information flows; between |
| | | | | customers, production processes, |
| | | | | and input suppliers; and between |
| | | | | business/economic operations |
| | | | | and the environment. See Value |
| | | | | Stream Map. |
| SLS | 6 | Transition/Stabilization | | Action plan that lays out specific |
| | | Plan | | steps (with timing and |
| | | | | responsibilities) to integrate a |
| | | | | new process or system in an |
| | | | | organization's or community's |
| | | | | normal operations, address the |
| | | | | disruptions to other processes or |
| | | | | communities, and achieve |
| | | | | stability. This plan typically |
| | | | | includes a process map that |
| | | | | delineates roles and |
| | | | | responsibilities after the end of a |
| | | | | project and formalizes the |
| | | | | handoff between project team |
| | | | | and the organization. |
| SLS | All | Triple Bottom Line | 3BL | A framework for sustainability |
| | | | | popularized by John Elkington |
| | | | | that evaluates performance and |
| | | | | sustainability in terms of social |
| | | | | and environmental outcomes in |
| | | | | addition to the traditional |
| | | | | economic outcomes. |
| SLS | 4 | Tunneling Opportunity | | Analysis that examines |
| | | Analysis | | opportunities to transition to a |
| | | | | lower-cost or lower-impact state |
| | | | | by going beyond the traditional |
| | | | | optimization model, which is |
| | | | | based on marginal impact |
| | | | | analysis (e.g., improve |
| | | | | efficiency incrementally until the |
| | | | | incremental costs begin to |
| | | | | outweigh the incremental |
| | | | | benefits). Example: super- |
| | | | | insulating a building may enable |
| | | | | elimination of the furnace and |
| | | | | heating system, with building |
| | | | | heat provided by the waste heat |
| | | | | of appliances and passive solar |
| | | | | heating. |
| SLS | 4 | Value As Services | | Creating business models based |
| | | Business Model | | on providing the services of a |
| | | | | product rather than the product |
| | | | | itself. Such models can help |
| | | | | correct agent problems, split |
| | | | | incentives, and externalities, |
| | | | | among other market failures; |
| | | | | such models can also enable |
| | | | | businesses to profit from |
| | | | | increases in the productivity of |
| | | | | natural resources and natural |
| | | | | capital. |
| SLS | 4 | Values-Based Marketing | | The practice of marketing |
| | | | | products, services, and |
| | | | | company/organizational |
| | | | | image/brand based on the values |
| | | | | embodied in the product/service, |
| | | | | its production process, or the |
| | | | | culture and priorities of the |
| | | | | company/organization. |
| SLS | 1, 4 | Voice of the Community | | The practice of ensuring that |
| | | | | community/societal concerns are |
| | | | | represented and given |
| | | | | appropriate consideration when |
| | | | | decisions are being made. |
| SLS | 1, 4 | Voice of the | | The practice of ensuring that |
| | | Environment | | environmental/ecological |
| | | | | concerns are represented and |
| | | | | given appropriate consideration |
| | | | | when decisions are being made. |
| SLS | 4 | Waste = Food | | Principle that the waste of one |
| | | | | organism, process, or |
| | | | | organization can serve as input |
| | | | | (food) for another. In Design |
| | | | | for the Environment, this |
| | | | | principle is used in selecting |
| | | | | materials and production |
| | | | | processes to assure that wastes, |
| | | | | byproducts, and the product |
| | | | | itself at the end of its life can be |
| | | | | turned into other products. |
| SLS | 1 | Working in Context | | The practice of doing business/ |
| | | | | community development |
| | | | | planning and visioning in the |
| | | | | community/business itself, |
| | | | | often with a hands-on |
| | | | | component. By working in |
| | | | | context, stakeholders understand |
| | | | | the actual problems that are |
| | | | | being manifested to afford the |
| | | | | possibility of developing elegant |
| | | | | simple solutions to complex |
| | | | | problems. The desire to use a |
| | | | | hands on component links and |
| | | | | commits the individual to the |
| | | | | appropriate context physically |
| | | | | which reinforces the emotional |
| | | | | and intellectual commitment to |
| | | | | the problem at hand. |
| SLS | 4 | World Café | | A dialogue technique in which |
| | | | | multiple small groups have |
| | | | | directed conversations on a |
| | | | | topic. Typically the |
| | | | | conversations take place in |
| | | | | several rounds in which 1 person |
| | | | | stays at a table while the other |
| | | | | participants rotate to different |
| | | | | tables, followed by a report-out. |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of undertaking and implementing a project using at least one concept, method or tool which integrates Lean Six Sigma and sustainability concepts, the method comprising:
a) collecting data regarding a project to be undertaken;
b) analyzing the collected data to identify a problem associated with the project;
c) defining a desired solution to the problem;
d) creating a plan of action based on the desired solution wherein at least one of steps a) through d) is performed utilizing at least one concept, method or tool which integrates Lean Six Sigma and financial and environmental sustainability concepts; and
implementing the plan of action to obtain financial and environmental benefits.

2. The method as claimed in claim 1 further comprising the step of identifying a team to solve the problem and refining scope of the project wherein the steps of identifying and refining are performed utilizing at least one concept, method or tool which integrates Lean Six Sigma and sustainability concepts.

3. The method as claimed in claim 1, wherein the at least one concept, method or tool includes at least a portion of a critical-to-sustainability tree.

4. The method as claimed in claim 3, wherein the desired solution is based on requirements of customers including environment.

5. The method as claimed in claim 1 further comprising measuring the financial and environmental benefits wherein the step of measuring is performed utilizing at least one concept, method or tool which integrates Lean Six Sigma and sustainability concepts.

6. The method as claimed in claim 5 further comprising sustaining the measured benefits to obtain sustained benefits wherein the step of sustaining is performed utilizing at least one concept, method or tool which integrates Lean Six Sigma and sustainability concepts.

7. The method as claimed in claim 6 further comprising communicating the sustained benefits wherein the step of communicating is performed utilizing at least one concept, method or tool which integrates Lean Six Sigma and sustainability concepts.

8. A method of undertaking and implementing a project using at least one concept, method or tool which integrates Lean Six Sigma and sustainability concepts, the method comprising:
a) collecting data regarding a project to be undertaken;
b) analyzing the collected data to identify a problem associated with the project;
c) defining a desired solution to the problem;
d) creating a plan of action based on the desired solution wherein at least one of steps a) through d) is performed utilizing at least one concept, method or tool which integrates Lean Six Sigma and financial and social concepts; and
implementing the plan of action to obtain financial and social benefits.

9. The method as claimed in claim 8 further comprising identifying a team to solve the problem and refining scope of the project wherein the steps of identifying and refining are performed utilizing at least one concept, method or tool which integrates Lean Six Sigma and sustainability concepts.

10. The method as claimed in claim 8, wherein the at least one concept, method or tool includes at least a portion of a critical-to-sustainability tree.

11. The method as claimed in claim 10, wherein the desired solution is based on requirements of customers including community.

12. The method as claimed in claim 8 further comprising measuring the financial and social benefits wherein the step of measuring is performed utilizing at least one concept, method or tool which integrates Lean Six Sigma and sustainability concepts.

13. The method as claimed in claim 12 further comprising sustaining the measured benefits to obtain sustained benefits wherein the step of sustaining is performed utilizing at least one concept, method or tool which integrates Lean Six Sigma and sustainability concepts.

14. The method as claimed in claim 13 further comprising communicating the sustained benefits wherein the step of communicating is performed utilizing at least one concept, method or tool which integrates Lean Six Sigma and sustainability concepts.

15. A method of undertaking and implementing a project using at least one concept, method or tool which integrates Lean Six Sigma and sustainability concepts, the method comprising:
a) collecting data regarding a project to be undertaken;
b) analyzing the collected data to identify a problem associated with the project;
c) defining a desired solution to the problem;
d) creating a plan of action based on the desired solution wherein at least one of steps a) through d) is performed utilizing at least one concept, method or tool which integrates Lean Six Sigma and financial, environmental and social concepts; and
implementing the plan of action to obtain financial, environmental and social benefits.

16. The method as claimed in claim 15 further comprising identifying a team to solve the problem and refining scope of the project wherein the steps of identifying and refining are performed utilizing at least one concept, method or tool which integrates Lean Six Sigma and sustainability concepts.

17. The method as claimed in claim 15, wherein the at least one concept, method or tool includes a critical-to-sustainability tree.

18. The method as claimed in claim 17, wherein the desired solution is based on requirements of customers including community and environment.

19. The method as claimed in claim 15 further comprising measuring the financial, environmental and social benefits wherein the step of measuring is performed utilizing at least one concept, method or tool which integrates Lean Six Sigma and sustainability concepts.

20. The method as claimed in claim 19 further comprising sustaining the measured benefits to obtain sustained benefits wherein the step of sustaining is performed utilizing at least one concept, method or tool which integrates Lean Six Sigma and sustainability concepts.

21. The method as claimed in claim 20 further comprising communicating the sustained benefits wherein the step of communicating is performed utilizing at least one concept, method or tool which integrates Lean Six Sigma and sustainability concepts.
